(19) United States
(12) Patent Application Publication
(10) Pub. No.: US 2010/0309280 A1
(43) Pub. Date: Dec. 9, 2010

(54) IMAGING PATTERNS OF FEATURES WITH VARYING RESOLUTIONS

(76) Inventor: Greg Peregrym, New Westminster (CA)

Correspondence Address: EASTMAN KODAK COMPANY;PATENT LEGAL STAFF, 343 STATE STREET, ROCHESTER, NY, 14650-2201, US

(21) Appl. No.: 12/864,514

(22) PCT Filed: Jan. 30, 2008
(86) PCT No.: PCT/IB08/00207

§ 371 Date: Jul. 26, 2010

(51) Int. Cl. B41J 2/435

(52) U.S. Cl. 347/246

(57) ABSTRACT

A method is provided for forming an image of a pattern of features on media with radiation beams emitted by an imaging head while scanning over the media along a scan direction. The method includes determining a pitch of a pattern of features along a first direction and controlling the imaging head to selectively emit the radiation beams to form the pattern of features on the media with a plurality of pixels that can include imaged pixels and non-imaged pixels. The plurality of pixels can include a first pixel having a first size along the scan direction and a second pixel having a second size along the scan direction. The second size can be different from the first size and is determined based at least on the pitch of the features along the first direction and the first size.

### TECHNICAL FIELD

The invention relates to imaging systems and to methods for forming images. The invention may be applied to fabricating color filters for electronic displays, for example.

### BACKGROUND

Color filters used in display panels typically include a pattern comprising a plurality of color features. The color features may include patterns of red, green and/or blue color features, for example. Color filters may be made with color features of other colors. The color features may be arranged in any of various suitable configurations. Prior art stripe configurations have alternating columns of red, green and blue color features as shown in FIG. 1A.

FIG. 1A shows a portion of a prior art “stripe configuration” color filter 10 having a plurality of red (R), green (G) and blue (B) color features 12, 14 and 16 respectively formed in alternating columns across a receiver element 18. Color features 12, 14 and 16 are outlined by portions of a color filter matrix 20 (also referred to as matrix 20). The columns can be imaged in elongated stripes that are subdivided by matrix cells 34 (also referred to as cells 34) into individual color features 12, 14 and 16.

Various imaging methods are known in the art and can be used to form various features on media. For example, laser-induced thermal transfer processes have been proposed for use in the fabrication of displays, and in particular color filters. When laser-induced thermal transfer processes are used to produce a color filter, a color filter substrate also known as a receiver element is overlaid with a donor element that is then image-wise exposed to selectively transfer a colorant from the donor element to the receiver element. Preferred exposure methods use radiation beams such as laser beams to induce the transfer of the colorant to the receiver element. Diode lasers are particularly preferred for their low cost and small size.

Laser-induced “thermal transfer” processes include: laser-induced “dye transfer” processes, laser-induced “melt transfer” processes, laser-induced “ablation transfer” processes, and laser-induced “mass transfer” processes. Colorants transferred during laser-induced thermal transfer processes include suitable dye-based or pigment-based compositions. Additional elements such as one or more binders may be transferred.

Some conventional laser imaging systems produce a limited number of radiation beams. Other conventional systems reduce the time required to complete images by producing many radiation beams with large numbers of individually-modulated imaging channels. Imaging heads with large numbers of such “channels” are available. For example, a SQUAREspot® model thermal imaging head manufactured by Kodak Graphic Communications Canada Company, British Columbia, Canada has several hundred independent channels. Each channel can have power in excess of 25 mW. An array of imaging channels can be controlled to write an image in a series of image swaths which are arranged to form a continuous image.

The stripe configuration shown in FIG. 1A illustrates one example configuration of color filter features. Color filters may have other configurations. Mosaic configurations have the color features that alternate in both directions (e.g. along columns and rows) such that each color feature resembles an “island”. Delta configurations (not-shown) have groups of red, green and blue color features arranged in a triangular relationship to each other. Mosaic and delta configurations are examples of “island” configurations. FIG. 1B shows a portion of a prior art color filter 10 arranged in a mosaic configuration in which color features 12, 14 and 16 are arranged in columns and alternate both across and along the columns.

Other color filter configurations are also known in the art. Whereas the illustrated examples described above show patterns of rectangular shaped color filter elements, other patterns including other shaped features are also known.

FIG. 1C shows a portion of a prior art color filter 10 with a configuration of triangular shaped color features 12A, 14A and 16A. As illustrated in FIG. 1C, each of the respective color features are arranged along columns and are aligned with matrix 20.

FIG. 1D shows a portion of a prior art color filter 10 with a configuration of triangular shaped color features 12A, 14A and 16A. As illustrated in FIG. 1D, each of the respective color features alternate along the columns and rows of color filter 10. As shown in FIGS. 1C and 1D, color features 12A, 14A and 16A can have different orientations within a given row or column.

FIG. 1E shows a portion of a prior art color filter 10 that includes a configuration of chevron shaped color features 12B, 14B and 16B. As illustrated in FIG. 1E, each of the respective color features are arranged along columns and are aligned with matrix 20. Color features 12B, 14B and 16B are formed from stripes that bend from side to side and are outlined by portions of a color filter matrix 20.

FIG. 1F shows a portion of a prior art color filter 10 that includes a configuration of chevron shaped color features 12B, 14B and 16B. As illustrated in FIG. 1F, each of the respective color features alternate along the columns and rows of color filter 10.

The shape and configuration of a color filter feature can be selected to provide desired color filter attributes such as a better color mix or enhanced viewing angles.

In some applications, it is required that the features be formed in substantial alignment with a registration region provided on a media. For example, in FIG. 1A the various color features 12, 14 and 16 are to be aligned with a pattern of matrix cells 34 that are provided by matrix 20. Color features 12, 14 and 16 can overlap matrix 20 to reduce backlight leakage effects. In some applications such as color filters, the visual quality of the final product can be dependant upon the accuracy with which a pattern of features (e.g. a pattern of color filter features) is aligned with a pattern of registration sub-regions (e.g. a color filter matrix). Misregistration can lead to the formation of undesired colorless voids or to the overlapping of adjacent features which can result in un-desired visual artifacts. While overlapping a matrix 20 can help to reduce the accuracy with which the color features must be aligned with matrix 20 in color filter applications, there are typically limits to the extent that matrix 20 can be overlapped. Factors that can limit the degree of overlap (and final alignment) can include, but are not limited to: the particular configuration of the color filter, the width of the matrix lines, the roughness of the matrix lines, the minimum overlap required to prevent backlight leakage, and post annealing shrinkage.

The imaging process itself can have an effect on the degree of overlap that is permitted. For example, the visual quality of an image produced in a laser-induced thermal transfer process is typically sensitive to the uniformity of the interface between the donor element and the receiver element. Non-uniform interfaces can affect the amount of image forming material that is transferred from the donor element to the receiver element. If adjacent features overlap one another over matrix lines, the donor-to-receiver element spacing can additional vary in the overlapped regions as a function of the additional material that has been transferred to these regions. This added spacing can adversely impact the visual quality of features that are formed during a subsequent imaging with an additional donor element. In this regard, it is typically preferred that adjacent features not overlap themselves over a matrix portion. This requirement places additional constraints on the required alignment between the pattern of repeating color features and the repeating pattern of matrix cells.

When laser imaging processes are employed, the imaging resolution with which the laser imager can scan radiation beams across the media typically has a bearing on the final alignment that is obtained. The resolution associated with the imaging process is related to a size characteristic of a pixel formed by a corresponding radiation beam emitted by an imaging channel. Given that an image pixel formed by a radiation beam has a distinct size and that an imaged feature is formed by various arrangements of the pixels, the size or placement of the imaged feature may vary from a desired size or placement of the feature as function of the pixel size. Although high resolutions (i.e. small pixel sizes) are typically preferred to provide finer control of the size of a feature, the exposure requirements of a given media can also limit the imaging process to use relatively low resolutions (i.e. relatively “large” pixels).

There remains a need for effective and practical imaging methods and systems that lead to the formation of high-quality images of features. The images can include patterns of features which need to be formed in substantial alignment with a pattern of registration sub-regions provided on a media.

There remains a need for effective and practical imaging methods and systems that can form patterns of features such that the pitch of the features (e.g. color filter features) match the pitch of the sub-regions in a pattern of registration sub-regions (e.g. cells in a color filter matrix).

There remains a need for effective and practical imaging methods and systems that allow a feature, or portion thereof, to be formed to a specific size while maintaining a desired pitch requirement between the feature and another feature.

### SUMMARY OF THE INVENTION

The present invention relates to a method for forming an image of a pattern of features on a media while the media is moved relative to a radiation beam. The media can include a pattern of registration sub-regions, such as, for example, a matrix. The image can include one or more patterns of features, such as color features for a color filter or colored illumination sources as part of an organic light emitting diode display. The one or more patterns of features can be registered with the pattern of registration sub-regions. The features could be island features wherein each feature of a first plurality of features of a first color is separated from each other feature of the first color by a feature of a different color. The features can be stripes which may be interrupted in one or more directions. The edges of the features can be skewed with respect to an arrangement direction of imaging channels of an imaging head.

The images can be formed by a laser-induced thermal transfer process such as a laser-induced dye-transfer process, a laser induced mass transfer process or by other means of transferring material from a donor element to a receiver element.

The method can include forming an image of a pattern of features on media with radiation beams emitted by an imaging head while scanning over the media along a scan direction. The image can include a pattern of features that are regularly arranged along a first direction. The method can include, for example, determining a pitch of the features along the first direction and controlling the imaging head to selectively emit the radiation beams to form the image of the pattern of features on the media with a plurality of pixels that include imaged pixels and non-imaged pixels. The pixels can be varied in size to accommodate the pitch of the pattern of features. For example, the plurality of pixels can include a first pixel having a first size along the scan direction and a second pixel having a second size along the scan direction. The second size is different from the first size and is determined based at least on the pitch of the features along the first direction and the first size.

The pattern of features may include a feature that repeats along the first direction. In one example embodiment, the pitch of the features along the first direction is not equal to an integer multiple of either the first size or the second size. In another example embodiment, the first size is determined based at least on a size along the first direction of a feature, a portion of a feature, or spacing along the first direction between adjacent features of the pattern of features. The second size can be determined based at least on a size along the first direction of a feature of the pattern of features.

Each of the first pixel and the second pixel can be imaged pixels and at least part of a feature of the pattern of features can be formed with the first pixel and the second pixel. A feature of the pattern of features can be formed with at least one imaged pixel and a spacing between the feature and an adjacent feature of the pattern of features with at least one non-imaged pixel. Some of the imaged pixels can have a size along the scan direction that is equal to one of the first size and the second size, and some of the non-imaged pixels can have a size along the scan direction equal to the other of the first size and the second size. A first portion of a feature of the pattern of features can be formed with one or more pixels that each have a size along the scan direction equal to the first size, and a second portion of the feature can be formed with one or more pixels having a size along the scan direction equal to the second size. The first portion of the feature can be different in size from the second portion of the feature at least in the first direction. The pitch of the features along the first direction may or may not be equal to an integer multiple of either the size along the first direction of the first portion of the feature or the size along the first direction of the second portion of the feature.

The features in the pattern of features can be regularly arranged along a second direction that intersects the first direction. A pitch of the features along the second direction can be determined and the imaging head can be controlled to form each of the first pixel and the second pixel with a third size along a direction that intersects the scan direction. The third size can be determined based at least on the pitch of the features along the second direction. The third size can be determined such that the pitch of the features along the second direction is equal to an integer multiple of the third size. The pixel sizes can be adjusted by rotating the imaging head to change a resolution of the imaging head or varying the length of time during which one or more of the light valve channels are turned on and off.

A program product can be designed to carry a set of computer-readable signals comprising instructions which, when executed by a controller, cause the controller to control an imaging head to selectively emit radiation beams to form the pixels as described above.

### BRIEF DESCRIPTION OF THE DRAWINGS

Embodiments and applications of the invention are illustrated by the attached non-limiting drawings. The attached drawings are for purposes of illustrating the concepts of the invention and may not be to scale.

FIG. 1A is a plan view of a portion of a prior art color filter;

FIG. 1B is a plan view of a portion of another prior art color filter;

FIG. 1C is a plan view of a portion of a prior art filter including triangular shaped features;

FIG. 1D is a plan view of a portion of another prior art filter including triangular shaped features;

FIG. 1E is a plan view of a portion of a prior art filter including chevron shaped features;

FIG. 1F is a plan view of a portion of another prior art filter including chevron shaped features;

FIG. 2A is representation of a desired alignment of a pattern of color filter features with a pattern of matrix cells;

FIG. 2B schematically shows a laser-induced thermal transfer process being used to fabricate the color filter 10 of FIG. 2A with an incorrect cross-scan resolution;

FIG. 3 is a schematic perspective view of the optical system of an example prior art multi-channel imaging head;

FIG. 4A schematically shows an imaging of the color filter of FIG. 2A as per an aspect of the invention;

FIG. 4B schematically shows an imaging of the color filter of FIG. 2A as per another aspect of the invention;

FIG. 5 is schematic representation of a zoom system 70 employed by an example embodiment of the invention;

FIG. 6A is a plan view of a portion of a desired “stripe configuration” color filter;

FIG. 6B is a detailed plan view of a portion of a stripe feature of FIG. 6A;

FIG. 6C schematically shows the stripe feature portion of FIG. 6B imaged with pixels whose size is based on a pitch criteria of the features.

FIG. 6D schematically shows the stripe feature portion of FIG. 6B imaged with pixels whose size is based on a size criteria of the features;

FIG. 6E schematically shows a prior art grid-like arrangement of pixels formed by scanning radiation beams;

FIG. 7 schematically shows an apparatus 90 used in an example embodiment of the invention;

FIG. 8 is flow chart representing a method practiced as per an example embodiment of the invention;

FIG. 9A schematically shows part of the stripe feature portion of FIG. 6B formed by using first pixels as per an example embodiment of the invention;

FIG. 9B schematically shows another part of the stripe feature portion of FIG. 6B formed by using second pixels different from the first pixels as per an example embodiment of the invention;

FIG. 9C schematically shows several parts of the stripe feature portion of FIG. 6B formed by using the first and second pixels of FIGS. 9A and 9B as per an example embodiment of the invention;

FIG. 9D schematically shows the stripe feature portion of FIG. 6B imaged with pixels as per another example embodiment of the invention;

FIG. 10 shows a portion of a color filter in which the red (R) color features, green (G) color features and blue (B) color features are regularly arranged in a mosaic configuration; and

FIG. 11 shows a pattern of unequally sized features that are arranged along a first direction with a uniform pitch.

### DETAILED DESCRIPTION

Throughout the following description specific details are presented to provide a more thorough understanding to persons skilled in the art. However, well-known elements may not have been shown or described in detail to avoid unnecessarily obscuring the disclosure. Accordingly, the description and drawings are to be regarded in an illustrative, rather than a restrictive, sense.

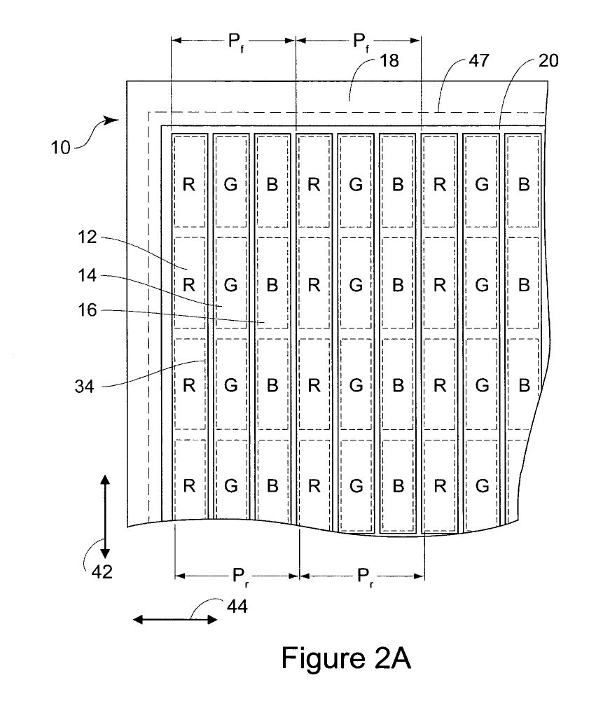

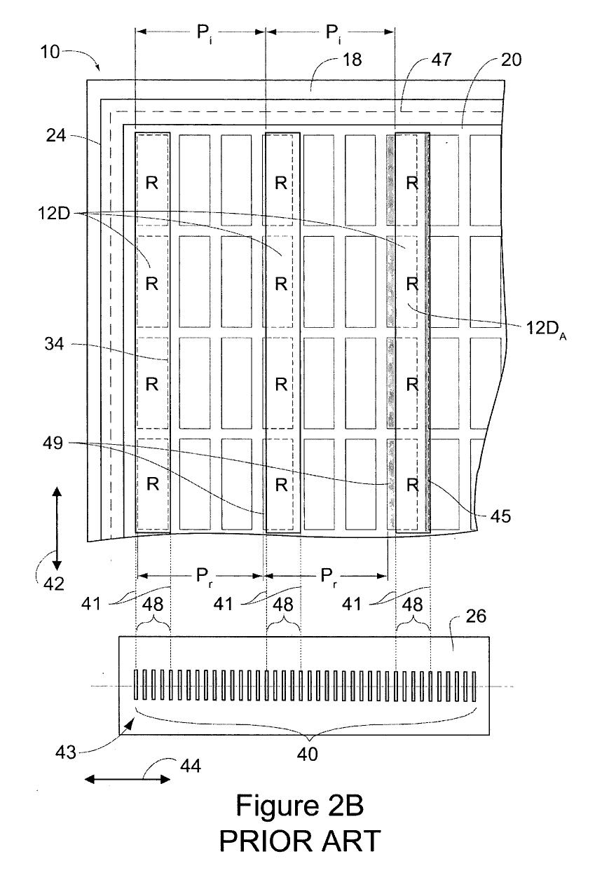

FIG. 2A shows an example of a desired alignment of a pattern of features with a registration region that includes a pattern of registration sub-regions. In this example, each feature extends along a direction that is parallel to main-scan axis 42 and the features are regularly arranged along a direction that is parallel to sub-scan axis 44. In this example, a color filter 10 includes a registration region 47 (shown in large broken lines) which includes a color filter matrix 20 (partially shown in small broken lines). Color filer matrix (also known as matrix 20) in turn includes a pattern of evenly spaced cells 34 formed on a receiver element 18. In this case, it is desired that red (R) stripe features 12, green (G) stripe features 14 and blue (B) stripe features 16 be formed in substantial alignment with matrix 20 to form a “stripe configuration” color filter. Accordingly, in this example, it is desired that the pitch “P_{f}” of each respective pattern of red stripe features 12, green stripe features 14 and blue stripe features 16 substantially equal the pitch “Pᵣ” of the pattern of respective registration sub-regions (i.e. cells 34). Features can be arranged in different patterns. In some patterns, the features are regularly arranged along one or more directions. In such patterns, each feature includes a common reference, such as a feature edge, a feature corner, a feature center point or other portion of a feature. The features are arranged such that each of the common references is separated from one another by an equal distance along an arrangement direction of the pattern of features. This equal distance is referred to as “pitch”.

Red stripe features 12, green stripe features 14 and blue stripe features 16 can be formed by various processes including imaging processes that employ radiation beams which are scanned across various media. In this case, the various features are to be formed with laser-induced thermal transfer processes. FIG. 2B schematically shows a laser-induced thermal transfer process being used to fabricate the color filter 10 of FIG. 2A. An imaging head 26 is provided to transfer image-forming material (not shown) from a donor element 24 to underlying receiver element 18. Donor element 24 is shown as being smaller than receiver element 18 for the purposes of clarity only. Donor element 24 may overlap one or more portions of receiver element 18 as required. Imaging head 26 can include an arrangement of various numbers of imaging channels. In this case, imaging head 26 includes a channel array 43 of individually addressable channels 40 that are uniformly sized and which repeat along an arrangement direction of the array. In this case, the arrangement direction is parallel to sub-scan axis 44. Image forming material is image-wise transferred from donor element 24 onto the receiver element 18 when radiation beams (not shown) emitted by imaging head 26 are scanned across donor element 24. Red, green and blue portions of filter 10 are typically imaged in separate imaging steps; each imaging step involving replacing the preceding color donor element with the next color donor element to be imaged. Each of the red, green and blue features of the filter is to be transferred to receiver element 18 in substantial alignment with a corresponding matrix cell 34. In FIG. 2B, only the imaging of red stripe features 12D is shown. The imaging of green stripe features and blue stripe features are not shown for clarity.

After the color features have been transferred, the imaged color filter may be subjected to one or more additional process steps, such as an annealing step, for example, to change one or more physical properties (e.g. durability) of the imaged color features.

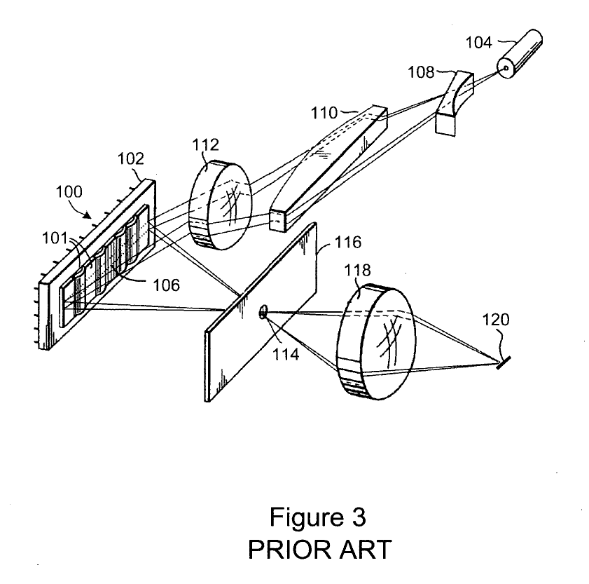

An example of an illumination system employed by a laser-based multi-channel imaging process is schematically shown in FIG. 3. A spatial light modulator or light valve is used to create a plurality of imaging channels. In the illustrated example, linear light valve array 100 includes a plurality of deformable mirror elements 101 fabricated on a semi-conductor substrate 102. Mirror elements 101 are individually addressable. Mirror elements 101 can be micro-electro-mechanical (MEMS) elements, such as deformable mirror micro-elements, for example. A laser 104 can generate an illumination line 106 on light valve 100 using an anamorphic beam expander comprising cylindrical lenses 108 and 110. Illumination line 106 is laterally spread across the plurality of elements 101 so that each of the mirror elements 101 is illuminated by a portion of illumination line 106. U.S. Pat. No. 5,517,359 to Gelbart describes a method for forming an illumination line.

A lens 112 typically focuses laser illumination through an aperture 114 in an aperture stop 116 when elements 101 are in their un-actuated state. Light from actuated elements is blocked by aperture stop 116. A lens 118 images light valve 100 to form a plurality of individual image-wise modulated beams 120, which can be scanned over the area of a substrate to form an imaged swath. Each of the beams is controlled by one of the elements 101. Each element 101 corresponds to an imaging channel of a multi-channel imaging head.

Each of the radiation beams is operable for imaging, or not imaging, a “pixel” on the imaged receiver element in accordance with the driven state of the corresponding element 101. That is, when required to image a pixel in accordance with image data, a given element 101 is driven to produce a corresponding radiation beam with an intensity magnitude and duration suitable for forming a pixel image on the substrate. When required not to image a pixel in accordance with the image data, a given element 101 is driven to not produce a radiation beam. As used herein, pixel refers to a single element of image on the substrate, as distinguished from the usage of the word pixel in connection with a portion of an image displayed on an assembled display device. For example, if the present invention is used to create a filter for a color display, the pixels created by the present invention will be combined with adjacent pixels, to form a single pixel (also referred to as a feature) of an image displayed on the display device.

FIG. 2B depicts the correspondence between imaging channels 40 and the transferred pattern as broken lines 41. Features, such as imaged stripe features 12D generally have sizes that are greater than a width of a pixel imaged by an imaging channel 40 and are therefore imaged by a plurality of pixels (not shown). The radiation beams generated by imaging head 26 are scanned over receiver element 18 while being image-wise modulated according to image data specifying the pattern of features to be written. Groups 48 of channels are driven to produce radiation beams wherever it is desired to form a feature. Channels 40 not corresponding to the features are driven so as not to form images on corresponding areas.

Receiver element 18, imaging head 26, or a combination of both, can be moved relative to one another while imaging channels 40 are controlled in response to image data to create image swaths. In some cases, imaging head 26 is stationary and receiver element 18 is moved. In other cases, receiver element 18 is stationary and imaging head 26 is moved. In still other cases, both the imaging head 26 and the receiver element 18 are moved.

Imaging channels 40 can be activated to form an image swath during a scan of imaging head 26. Receiver element 18 can be too large to be imaged within a single image swath. Therefore, multiple scans of imaging head 26 are typically required to complete an image on receiver element 18.

Movement of imaging head 26 along sub-scan axis 44 may occur after the imaging of each swath is completed along main-scan axis 42. Alternatively, with a drum-type imager, it may be possible to relatively move imaging head 26 along both the main-scan axis 42 and sub-scan axis 44, thus writing the image swath extending helically on the drum. In FIG. 2B, relative motion between imaging head 26 and receiver element 18 is provided along a path aligned with main-scan axis 42.

Any suitable mechanism may be applied to move imaging head 26 relative to receiver element 18. Flat bed imagers are typically used for imaging receiver elements 18 that assume a relatively rigid and flat orientation as is common in fabricating display panels. A flat bed imager has a support that secures a receiver element 18 in a flat orientation. U.S. Pat. No. 6,957,773 to Gelbart describes a high-speed flatbed imager suitable for display panel imaging. Alternatively, flexible receiver elements 18 can be secured to either an external or internal surface of a “drum-type” support to affect the imaging of the image swaths.

In FIG. 2B, plural radiation beams are scanned in a scan direction that results in an image swath that is substantially parallel to main-scan axis 42. This scanning orientation may not however be appropriate in all circumstances since matrix 20 can assume a skewed orientation with respect to main-scan axis 42 and sub-scan axis 44. Skewed orientations of matrix 20 can occur for a number of reasons including placement errors of receiver element 18 within the imaging device. Skewed orientations require the various imaged features to be formed in a skewed manner to be aligned correctly with matrix 20. Skewed features or features with skewed edges have been imaged by establishing controlled relative motion between receiver element 18 and imaging head 26 as radiation beams are directed along scan paths. In this case, sub-scan motion is coordinated with main-scan motion in accordance with the degree of skew. As main-scan motion is provided between imaging head 26 and receiver element 18, synchronous sub-scan motion between the two is also provided to create a motion referred to as “coordinated motion”. Unlike drum-based imaging methods where image swaths are imaged in a helical fashion in which the amount of sub-scan motion during each drum rotation is typically defined independently of the image to be formed, the amount of sub-scan motion during each scan is dependant on the image to be formed when coordinated motion techniques are employed. Coordinated motion can be used to form features with edges that are substantially smooth and continuous which in some demanding applications can be used to facilitate and alignment of a pattern of features with a pattern of registration sub-regions.

FIG. 2B schematically shows the difficulties of imaging the pattern of features shown in FIG. 2A with the illustrated imaging techniques. Imaged stripe features 12D are formed in an attempt to image the desired red stripe features 12 of FIG. 2A in alignment with corresponding cells 34. In this exemplary case imaging head 26 assumes an orientation wherein an arrangement direction of imaging channels 40 is substantially parallel to an arrangement direction of the pattern of cells 34. As shown in FIG. 2B, the imaging channels 40 in array 43 have a resolution that cannot image the desired repeating pattern of red stripe features 12D with a pitch that is equal to pitch Pᵣ of cells 34. Essentially, the resolution of imaging channels in a cross-scan direction (i.e. a direction that intersects the scanning direction) cause imaged red stripe features 12D to be formed with an initial pitch Pᵢ that is not equal to Pᵣ. In this case the cross-scan direction is parallel to sub-scan axis 44.

The ability to control the size and position of each of the imaged red stripe features 12D is a function of pixel size. The radiation beams generated by imaging head 26 each create a pixel with a size along the cross-scan direction that cannot form the imaged pattern of imaged red stripe features 12D with a pitch that matches the pitch of the desired pattern of red stripe features 12. That is, the desired pitch is not equal to an integer multiple of the pixel size along the cross-scan direction. Although the resolution of the imaging channels 40 may, or may not cause each of the red stripe features 12D to be imaged with a size along a cross-scan direction that is equal the corresponding size of desired red stripe features 12, the resolution is such that the desired pitch cannot be matched.

As shown in FIG. 2B, the imaged red stripe features 12D are offset from corresponding cells 34 by varying amounts. In this case some of the offsets have increased to a point in which red stripe features 12D_{A} would be overlapped by other features imaged with other color donor elements in region 45 of matrix 20. Also, in regions 49, some matrix cells 34 have not been completely covered with a red stripe feature 12D thereby leading to a potential for a color-less void to be formed. Both these effects can lead to undesired visual characteristics in the final color filter. It becomes apparent that these effects can be additionally compounded as arrangements of larger number of imaging channels 40 are employed to enhance imaging productivity. It is to be noted that regions 45 and 49 are shaded for clarity.

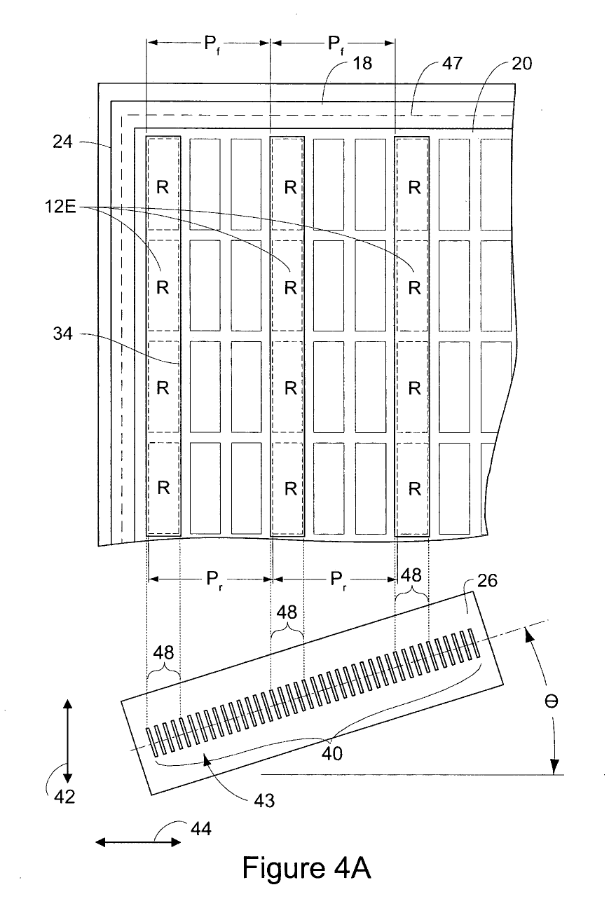

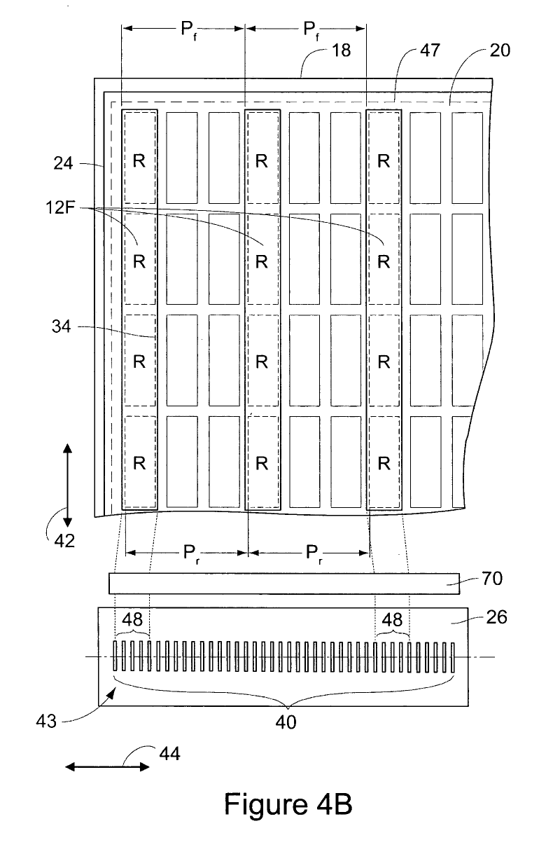

FIG. 4A schematically shows an imaging of the receiver element 18 shown in FIG. 2A as per an aspect of the invention. FIG. 4A shows only an imaging process related to desired red stripe features 12 of FIG. 2A. Desired green stripe features 14 and blue stripe features 16 are not considered for clarity, but can treated in much the same fashion as the imaging of desired red stripe feature 12. Red stripe features 12E are imaged with the same imaging head 26 shown in the imaging process shown in FIG. 2B. In accordance with this aspect of the invention, imaging head 26 is rotated by an angle θ as measured between sub-scan axis 44 and an arrangement direction of imaging channels 40. Angle θ is selected so that the resolution of the rotated imaging head 26 is appropriately sized to cause the imaged pattern of red stripe features 12E to be formed with a pitch P_{f} that is substantially equal to the pitch Pᵣ of cells 34. The desired pitch is now equal to an integer multiple of a cross-scan size of the pixels (not shown) used to form the pattern of red stripe features 12E. Rotation of imaging head 26 causes a size of the imaged pixels to change. The resulting size of the imaged pixels may, or may not cause imaged red stripe features 12E to be formed with cross-scan sizes that are equal to the corresponding cross-scan sizes of the desired red stripe features 12 shown in FIG. 2A. However, by adjusting the pixels to a size appropriate for the required pitch, many of the previously described artifacts that would arise from mismatched pitches are substantially avoided.

Although in FIG. 4A, imaging head 26 was rotated by angle θ as referenced from sub-scan axis 44, it is understood that other references could just as easily be used.

Other methods can be employed to change a size of an imaged pixel along directions that intersect the scanning direction. FIG. 4B schematically shows the imaging of the receiver element 18 shown in FIG. 2A as per another aspect of the invention. For clarity, FIG. 4B shows only an imaging process related to desired red stripe features 12. As per this aspect of the invention, imaging head 26 includes zoom mechanism 70. Zoom mechanism 70 adjusts a size of the radiation beams emitted by imaging head 26 such that the pattern of imaged red stripe features 12F are imaged with a pitch P_{f} that is substantially equal to the pitch Pᵣ of cells 34.

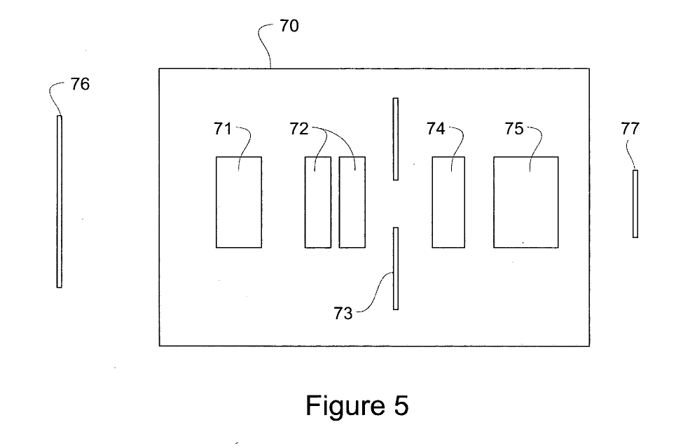

FIG. 5 schematically shows a zoom system 70 that can be employed by various embodiments of the invention. Zoom system 70 includes a fixed field optical component 71, two or more movable zoom optical components 72, an aperture stop 73, a fixed optical component 74 and a moveable focus optical component 75. In this example embodiment, aperture stop 73 is located between the zoom optical components 72 and the fixed optical components 74. Zoom mechanism 70 maintains the locations of the object plane 76 and the image plane 77 through the zoom adjustment range. The location of the zoom optical components 72 are moved between various positions to set the magnification of the optical system. Each of the optical components can include one or more lenses. One or more of the optical components can be anamorphic. Other types of zoom mechanisms can also be employed by this invention.

A required pitch may be determined in various ways. For example, the pitch of a pattern of registration sub-regions (e.g. a matrix) can be determined by direct measurement. Various optical sensors can be used to detect the position of various registration sub-regions and the detected positions can be use to determine the pitch between the sub-regions. Sizes of the pixels, radiation beams or the image swath itself can also be determined by direct measurement and can be used to help match the pitch of a pattern of features to the pitch of a pattern of registration sub-regions. Various pitches can be determined in various directions and need not be limited to directions that intersect the scan direction. Patterns of features can include patterns of features in which the features are regularly arranged along different directions. These patterns can further complicate the imaging process.

FIG. 2A shows a simplified “stripe configuration” color filter in which color filter features of a given color are produced by forming stripe features extended along the scan direction in alignment with matrix 20. As previously described, the various stripe features 12, 14 and 16 need to be formed with sufficient control that allows a “pitch match” in a cross-scan direction between the stripe features and the cells 34. Such control does not appear to be required along the scan direction in the simplified case shown in FIG. 2A as the stripe features extend essentially in an uninterrupted manner along this direction.

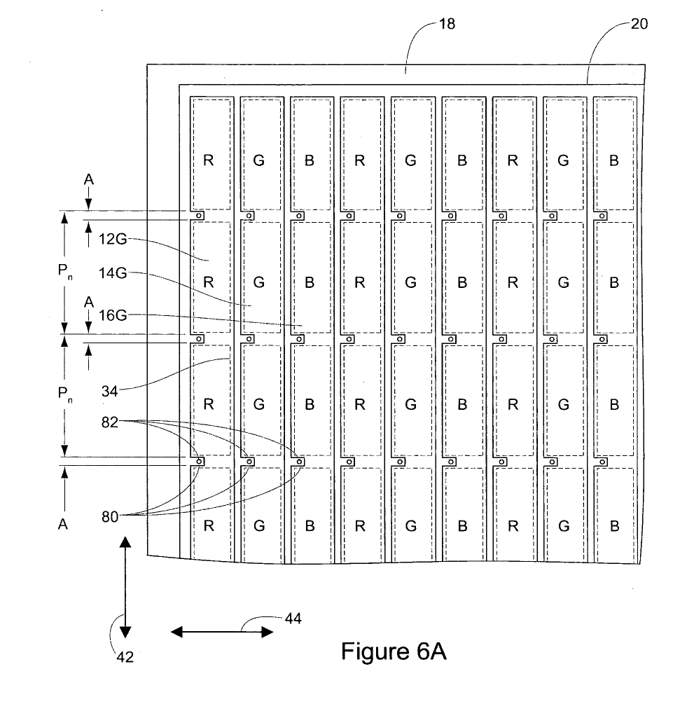

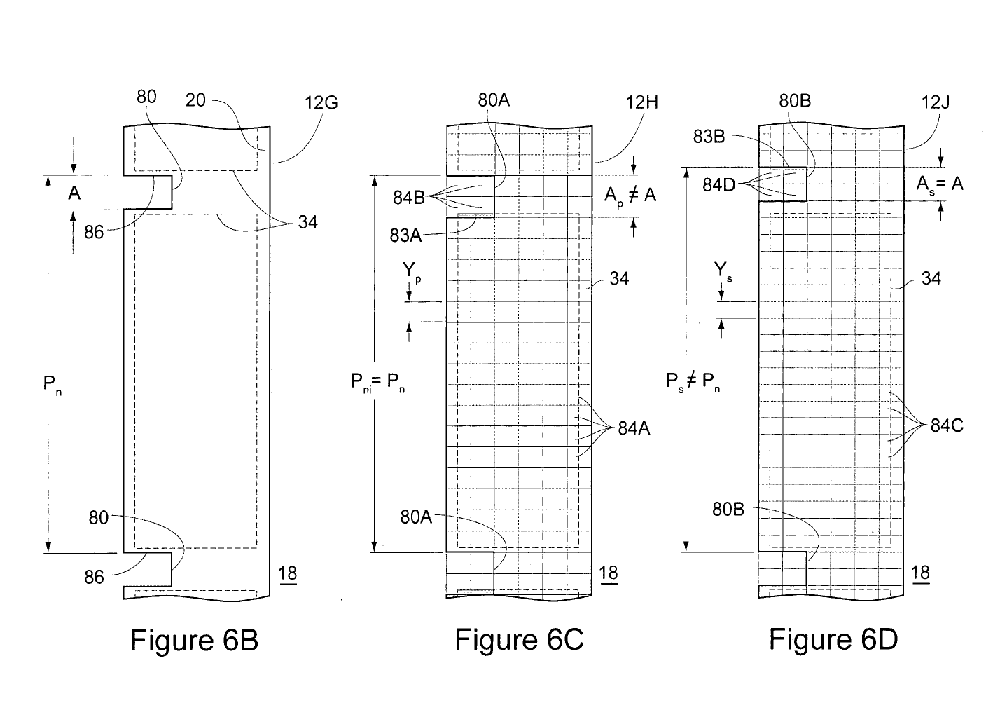

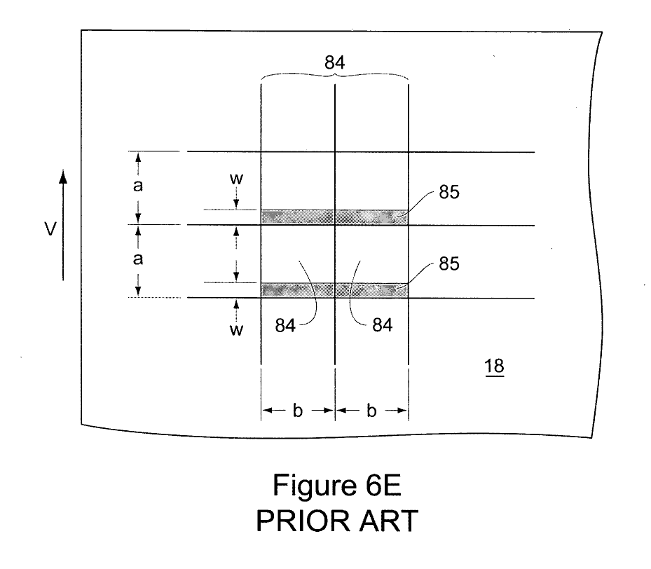

FIG. 6A shows another desired stripe configuration color filter 10. In this case each of the red (R) stripe features 12G, green (G) stripe features 14G and blue (B) stripe features 16G comprise various edges that extend in directions that in this case are parallel to main-scan axis 42. Some of these edges are interrupted. In this case the interruption consists of notches 80 that are regularly arranged at various positions along the stripes. Notches 80 can be required for different reasons. In this case, notches 80 are required to accommodate the positioning of various pattern spacers 82 that are mounted on receiver element 18.

Pattern spacers 82 are used to control the gap between receiver element 18 and a thin film transistor array panel (TFT) (not shown) which forms part of the assembled final display. Interposed between receiver element 18 and the TFT panel is a liquid crystal material (also not shown). Characteristics of the liquid crystal material are changed in accordance with various electric signals to allow for the activation or deactivation of a selected color filter feature. The visual quality of a display incorporating the color filter is dependant on maintaining a substantially uniform spacing between receiver element 18 and the TFT. Deviations in this spacing can cause objectionable visual artifacts (e.g. Mura defects) to occur. The various pattern spacers 82 are employed to establish this substantially uniform spacing. The various pattern spacers 82 are preferably mounted directly onto the substrate of receiver element 18 or onto matrix 20 rather than onto any image forming material that has been transferred onto the receiver element or the matrix lines during the formation of the various filter color features. This is done to avoid the variability that may be associated with the thickness of the transferred image forming material. As shown in FIG. 6A, pattern spacers 82 are formed directly on various areas of matrix 20. Each of the striped features 12G, 14G and 16G is notched in the vicinity of these areas.

Each of the notches 80 is governed by particular size and placement constraints. In this case, each notch 80 belongs to a pattern of notches 80 in which each of the notches 80 are positioned in accordance with a pitch Pₙ. Pitch Pₙ is required to position each of the notches 80 at desired locations with respect to matrix 20 to accommodate the positioning of pattern spacers 82. Failure to form notches 80 with the desired pitch Pₙ can cause the notches 80 to be incorrectly positioned along the stripe direction which can affect the required positioning of pattern spacers 82.

Each notch 80 has a size A along the stripe direction that is governed by various constraints. In this case, each of the notches must be sufficiently large to accommodate the size of a corresponding pattern spacer 82. Additionally, each notch 80 must be sized to fall within the line width of matrix 20 since a colorless void could result in adjacent cell 34 area if the notch is formed outside the boundary of the matrix line. Factors such as the positional tolerances of the pixels used to form each of the stripe features and their associated notches 80 typically require some additional margin between the edge of a matrix line and the edge of the notch. Typical color filter matrix line widths are usually on the order of approximately 20 microns or so, and there is a strong desire to employ thinner lines. Smaller line widths can lead to additional significant challenges in the accurate formation of these interrupted features with conventional imaging techniques.

FIGS. 6B, 6C, and 6D schematically show a conflict between the requirements to match “pitch” and match “size”. FIG. 6B shows a detailed view a portion of a desired stripe feature 12G shown in FIG. 6A. Desired stripe feature 12G is shown in relation to cells 34 (shown in broken lines) formed in a portion of matrix 20. In this case, pitch Pₙ is not equal in size to an integer multiple of size A of notch 80. The notch is formed typically by a plurality of pixels. A pixel size must be found which is greater than the minimum pixel size that can be formed. An integer number of pixels are needed to create the desired notch size and an integer number of the pixels must match the pitch Pₙ.

FIGS. 6C and 6D show arrangements of pixels formed on receiver element 18 during a imaging process employing an imaging head (not shown) controlled in accordance with image data. Various pixels are defined on a media as radiation beams are scanned along scan lines across the media to form imaged pixels 84A and 84C in imaged regions and non-imaged pixel 84B and 84D in non-imaged regions (all imaged and non-imaged pixels being collectively referred to as pixels 84). In these examples, formed stripe features 12H and 12J extend along a direction that is parallel to the scan direction that was used to form pixels 84.

Each pixel 84 can comprise different sizes in different directions. In this case, imaged pixels 84A and 84C have different sizes along the scan direction. Non-imaged pixels 84B and 84D also have different sizes along the scan direction. Such pixels can be created in various manners. For example, FIG. 6E schematically shows a prior art grid-like arrangement of pixels 84 formed by scanning radiation beams (not shown) over a receiver element 18. Each of the pixels 84 has a size “a” along a scan direction associated with the formation of pixels 84 and a size “b” in a cross-scan direction. In this example, a particular size of each pixel 84 is produced by scanning a rectangular radiation spot 85 over the area of each pixel 84. The scanning is achieved as part of the overall scanning of the image. In order to scan a spot over the pixel region, a relative motion having a velocity “V” is required. The relative motion can be generated by moving the radiation spot 85, or by moving receiver element 18, or by moving both. In this case the scan direction is parallel to the direction of the relative movement and the size of the spot in the scan direction is “w”. The time that the laser spot dwells over any point of the media is defined by w/V. In this case, the size in the scan direction of a pixel comprising an imaged pixel is a function of an initial size of a radiation beam “w” used to form the pixel and the duration of time in which that beam is scanned across receiver element 18. Conversely, the size along the scan direction of a non-imaged pixel is a function of the duration of time that no radiation beam is scanned across receiver element 18. Although the size along the scan direction can be adjusted by varying velocity, this could result in a change in the exposure created by the radiation beam. A common method of changing pixel size along the scan direction for a given scanning speed involves adjusting the length of time during which an imaging channel is activated. For example, in some imaging systems that include light valves, a timing signal that includes a pattern of timing pulses is provided to all of the light valve elements and individual elements are activated in accordance with image data. The time between the timing pulses is related to the length of time that each light valve element can be activated or not activated as a function of the image data and consequently defines a size along the scan direction of the pixels formed in accordance with the image data.

Rectangular radiation spots 85 can be created by various methods, including using rectangular apertures. The spot need not be rectangular however and can include other shapes as desired. Other methods of changing pixel sizes are also known in the art.

In FIG. 6C, the size of the pixels 84 along the scan direction has been selected to cause the imaged stripe feature 12H to be imaged such that the pitch requirements are met. That is, the pitch Pₙᵢ of the imaged notches 80A matches the desired pitch Pₙ of the desired notches 80 in FIG. 6B. In this case, the radiation beams have been activated and deactivated throughout the scan to form imaged pixels 84A and non-imaged pixels 84B, each with a size Yₚ that allows the desired pitch to be achieved. In other words, the resolution of the imaging system in scan direction has been adjusted to match “pitch” and the desired pitch Pₙ is substantially equal to an integer multiple of size Yₚ. This resolution however cannot form notches 80 with the desired size A in the scan direction. As shown in FIG. 6C, the imaged notches 80A have a size Aₚ that is larger than the desired size A shown in FIG. 6B. This imaging resolution has resulted in the imaged notches 80A extending into a region 83A of cell areas 34, an effect which can lead to an undesired visual artifact. Region 83A has been shaded for clarity.

FIG. 6D shows an arrangement of pixels 84 formed on receiver element 18 during an imaging process employing an imaging head (not shown) controlled in accordance with image data. Unlike FIG. 6C, the size of the pixels 84 along the scan direction in FIG. 6D has been selected to form imaged stripe features 12J with notches that have sizes Aₛ along the scan direction (again parallel to the direction in which the stripe feature extends) that substantially equal the desired sizes A shown in FIG. 6B. In this case the radiation beams have been activated and deactivated throughout the scan to form pixels 84 with a size Yₛ that allows the desired size A to be achieved. In other words, the resolution of the imaging system in scan direction has been adjusted to match “size” since size Yₛ has been selected so that size A is an integer multiple of size Yₛ. This resolution however cannot form notches 80B with the desired pitch Pₙ in the scan direction as the imaged notches are spaced with a pitch Pₛ that is not equal to desired pitch Pₙ. In this case, desired pitch Pₙ is not equal to an integer multiple of pixel size Yₛ. As shown in FIG. 6D, the imaged notch 80B is offset from its intended positions shown in FIG. 6B. This has resulted in the imaged notch 80B being partially formed into region 83B of cell area 34. This can lead to undesired visual artifacts. Region 83B has been shaded for clarity. It will quickly become apparent to those skilled in the art that this problem is further compounded since the resulting amount of offset between the formed notches 80B and cells 34 can vary as additional pixels 84 are continuously formed along the scan direction.

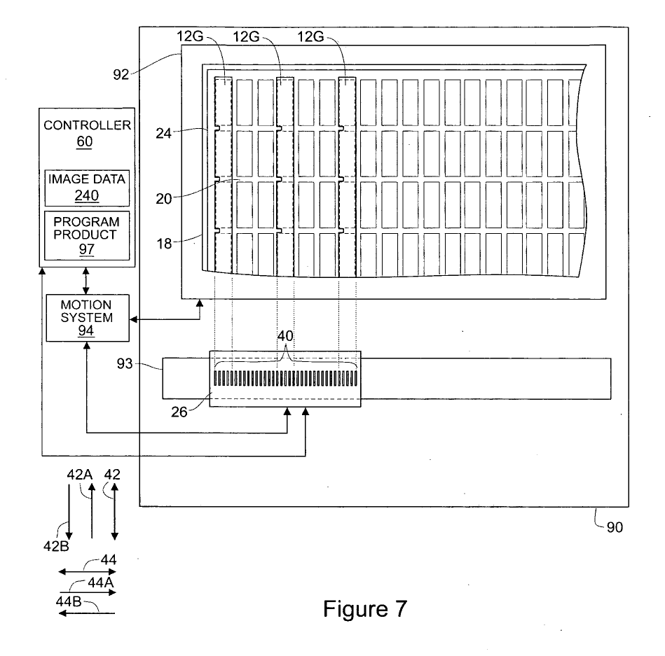

FIG. 7 schematically shows an apparatus 90 used in an example embodiment of the invention. Apparatus 90 is operable for forming images on receiver element 18. In this example embodiment of the invention, images are formed on receiver element 18 by operating imaging head 26 to direct radiation beams while scanning over receiver element 18.

Apparatus 90 includes carrier 92 which is operable for conveying receiver element 18 along a path aligned with main-scan axis 42. Carrier 92 can move in a reciprocating fashion. In this example embodiment of the invention, carrier is movable in a forward direction 42A and a reverse direction 42B. Imaging head 26 is movably arranged on a support 93 that straddles carrier 92. Imaging head 26 is controlled to move along paths aligned with sub-scan axis 44. In this example embodiment of the invention imaging head 26 can be controlled to move along support 93. Imaging head 26 is movable in away direction 44A and in home direction 44B. Apparatus 90 forms images by bi-directionally scanning receiver element 18.

In this example embodiment of the invention, a laser induced thermal transfer process is employed. Imaging head 26 is controlled to scan the media with a plurality of radiation beams to cause an image forming material (not shown) to be transferred from donor element 24 to receiver element 18. Imaging electronics (not shown) control the imaging channels 40 to regulate the emission of the radiation beams. An imaging channel 40 can be turned “on” to emit a radiation beam. In this case, a radiation beam can be used to transfer material from donor element 24 to receiver element 18 along a scan line corresponding to the channel. An imaging channel 40 may also be turned “off” so that a radiation beam is not emitted. The intensity of each beam is controllable from an inactive intensity level in which the imaging channel is turned “off” to an active intensity level in which the channel is turned “on”. The inactive intensity level can include an intensity level equal to zero or some small intensity level representative of various leakage effects. Some example embodiments of this invention (e.g. those employing independently modulated laser sources) have inactive intensity levels equal to zero.

Motion system 94 (which can include one or more motion systems) includes any suitable drives, transmission members, and/or guide members to cause the motion of carrier 92. In this example embodiment of the invention, motion system 94 controls the motion of imaging head 26 and controls the motion of carrier 92. Those skilled in the related art will realize that separate motion systems can also be used to operate different systems within apparatus 90.

Controller 60, which can include one or more controllers, is used to control one or more systems of apparatus 50 including, but not limited to, motion system 94 used by carrier 92 and imaging head 26. Controller 60 can also control media handling mechanisms that can initiate the loading and/or unloading of receiver element 18 and donor element 24. Controller 60 can also provide image data 240 to imaging head 26 and control imaging head 26 to emit radiation beams in accordance with this data. Various systems can be controlled using various control signals and/or by implementing various methods. Controller 60 can be configured to execute suitable software and can include one or more data processors, together with suitable hardware, including by way of non-limiting example: accessible memory, logic circuitry, drivers, amplifiers, A/D and D/A converters, input/output ports and the like. Controller 60 can comprise, without limitation, a microprocessor, a computer-on-a-chip, the CPU of a computer or any other suitable microcontroller.

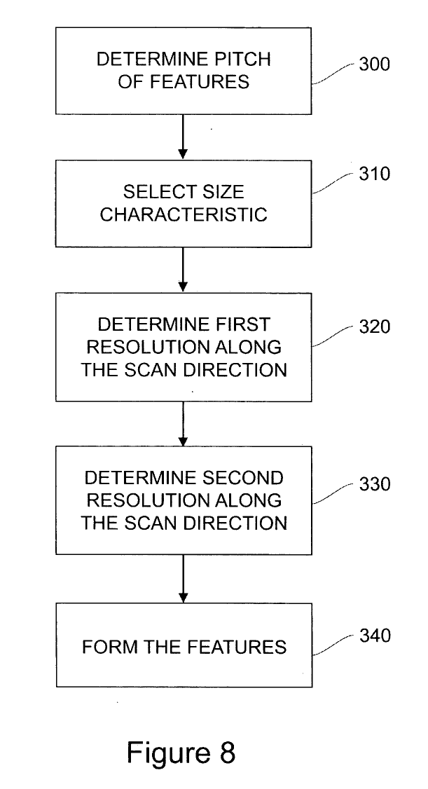

FIG. 8 shows a flow chart for imaging a pattern of features such as stripe features 12G, 14G and 16G shown in FIG. 6A as per an example embodiment of the invention. For clarity, only stripe features 12G will considered, although it is understood that respective patterns of stripe features 14G and 16G can be imaged by methods in accordance with this invention, or alternatively by other methods. The following description of the FIG. 8 flow chart refers to apparatus 90 as schematically shown in FIG. 7, although it is understood that other apparatus are suitable for use with the illustrated process.

The process begins a step 300 where a pitch of various features is determined. For example, with reference to FIG. 6B, stripe feature 12G can be viewed as an arrangement of contiguous features that include common reference edges 86 that are equal spaced from one another by a distance Pₙ.

In step 310, a feature size characteristic along a first direction is selected. In this example embodiment of the invention, the first direction is parallel to an arrangement direction of notches 80. In this example embodiment of the invention, the first direction is parallel to the scanning direction of the radiation beams that are emitted by imaging head 26. The feature size characteristic can include an overall size of the feature along the first direction, a size of a portion of the feature along the first direction, or a size of an element of the feature along the first direction. For example, with reference to FIG. 6B, notch 80 can be considered to be an element of each feature. A relevant size characteristic along the first direction is size A of notch 80.

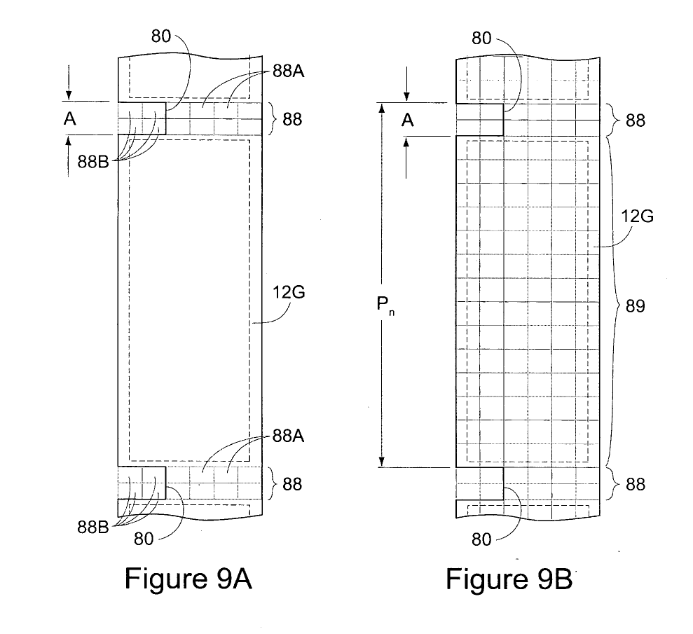

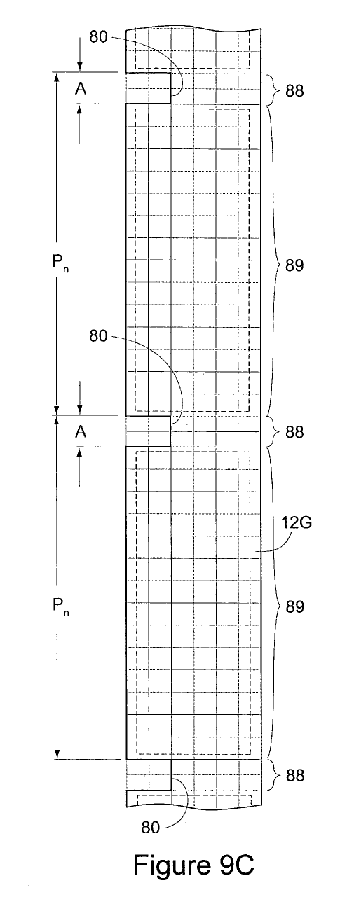

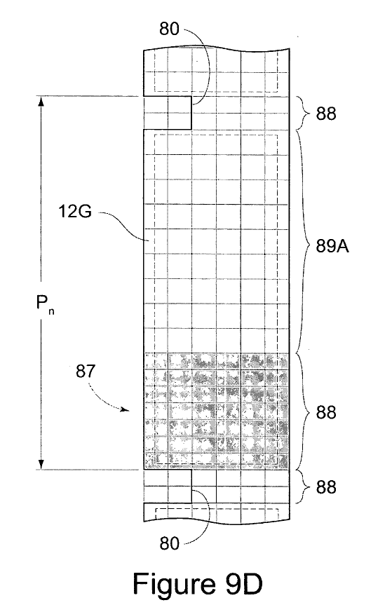

In step 320, a first resolution along the scan direction is determined based at least on the determined size characteristic along the first direction. For example, in the case of the notches 80 shown in FIG. 6B, a first resolution is chosen to produce first pixels 88 that have a first size along the scan direction that can form notches 80 with their desired size A. One possible arrangement of first pixels 88 is shown in FIG. 9A. This arrangement includes imaged pixels 88A and non-imaged pixels 88B which are arranged to form notch 80 and associated surrounding portions of the stripe feature.

In step 330, a second resolution along the scan direction different from the first resolution along the scan direction is determined in accordance with the pitch and the first resolution. For example, in the case of stripe feature 12G shown in FIG. 6B, a second resolution is selected to produce second pixels 89 that have a second size along the scan direction that can form remaining portions (i.e. in this example embodiment, feature portions other than those associated with notches 80) such that those portions are formed at their desired size and the desired pitch Pₙ of the features is maintained. In this example embodiment, the second size is determined based on the size of the remaining portion of feature 12G that is bounded by pitch Pₙ. One possible arrangement of second pixels 89 is shown in FIG. 9B. Pixels 89 can include imaged pixels and non-imaged pixels. In this example embodiment, second pixels 89 include suitable arrangements of imaged pixels that include a size along the scan direction that can form portions of the desired stripe feature 12G other than the portions associated with notches 80, and maintain the desired pitch. Advantageously, the stripe feature 12G is formed such that the pattern of color filter features are formed with a pitch that matches the pitch of the cells 34 of matrix 20 and the notches 80 of each feature is correctly sized. FIG. 9C shows a stripe feature 12G that has been imaged in accordance with the embodiment of the invention described above. Pixels 88 and 89 are formed along various scan lines to form stripe feature 12G.

The features are formed in step 340 by operating imaging head 26 to emit radiation beams to form pixels having the first size along the scan direction and pixels having the second size along the scan direction. In this example embodiment of the invention, the desired pitch Pₙ is not equal to an integer multiple of either the first size or the second size. In this example embodiment of invention, pixel sizes are varied by adjusting the duration of time that the imaging channels are activated to emit the beams. Other example embodiments of the invention can vary pixel size along the scan direction by other methods. It is understood that the sequence of steps shown in FIG. 8 are exemplary in nature and other sequences of these steps can be used in other embodiments of the invention.

In some example embodiments of the invention, patterns of features are imaged with a plurality of resolutions that can include more than two different resolutions. In some of these example embodiments of the invention, a pitch of the features in the pattern of features is not equal an integer multiple of at least one resolution of the plurality of scan resolutions (i.e. resolution along the scanning direction). In some example embodiments, additional portions of a feature can be imaged with pixels whose size along the scan direction has been determined in accordance with a size characteristic of a first portion of that feature. For example, FIG. 9D shows a variant of the example embodiment of the invention used to image stripe feature 12G in FIG. 9B. In FIG. 9D, portions of stripe feature 12G corresponding to notches 80 are imaged with pixels 88 whose sizes are determined as previously described. FIG. 9D however shows that an additional portion 87 (shaded for clarity) of stripe feature 12G is also imaged with pixels 88. A remaining portion of stripe feature 12G is imaged with pixels 89A whose sizes are determined in accordance with the desired pitch Pₙ and the size of the pixels 88. In this example embodiment of the invention, desired pitch Pₙ is not equal to an integer multiple of any of the imaged portions of stripe feature 12G.

In some example embodiments, one or more portions of a given feature can be imaged with a determined scan resolution that is different than other scan resolutions that are employed to image a spacing between that feature and a neighboring feature such as an adjacent feature in a pattern of the features. However, the various scan resolutions are appropriately determined such that they combine to cause the features to be imaged in accordance with the desired pitch of the pattern of features. In some of these example embodiments, the pitch may not be equal to an integer multiple of a size of the spacing. The desired pitch may not be equal to an integer multiple of a size of a portion of at least one of the features that is imaged with one of the resolutions.

In some example embodiments of the invention, the pattern of features is a two dimensional pattern of features, in which the features are regularly arranged along a first direction and along a second direction that intersects the first direction. In these embodiments, the features can be imaged with pixels in which the size of the pixels along the scan direction and along a direction that intersects the scan direction are adjusted to cause the features to be formed with their desired pitches along both of the corresponding first and second directions.

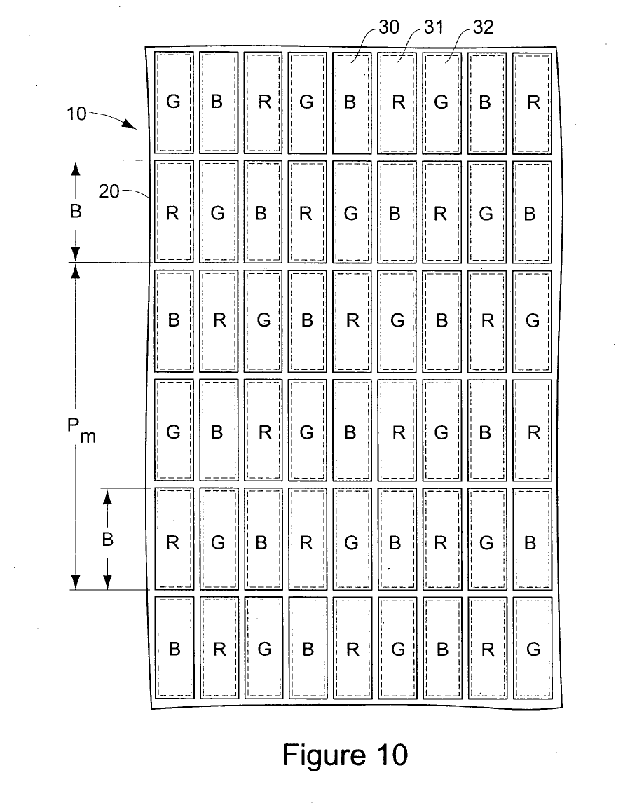

Various example embodiments of the invention have been described in terms of imaging stripe features. The invention however is not limited to imaging stripes but can be used to image features that include other shapes and configurations. The invention can be used to image island features also. For example, FIG. 10 shows a portion of a color filter 10 in which the red (R) color features 30, green (G) color features 31 and blue (B) color features 32 are regularly arranged in a mosaic configuration in which each of the various features are sized to only partially overlap surrounding matrix 20 lines. When thermal transfer techniques are employed, it is typically desired that features of different colors not overlap each other over a matrix line. Changes in the donor-to-receiver element spacing can alter how image forming material is transferred to the receiver element. FIG. 10 shows by way of example, that red features 30 are required to have a particular size B and to be arranged with a particular pitch Pₘ along an arrangement direction of the pattern. In this example embodiment, pitch Pₘ is not equal to an integer multiple of size B. Red features 30 and the spaces between them can be formed with various groups of differently sized pixels which include imaged pixels and non-imaged pixels. The various groups of pixels can have pixels that vary in size within each group or between each group in accordance with example embodiments of the invention.

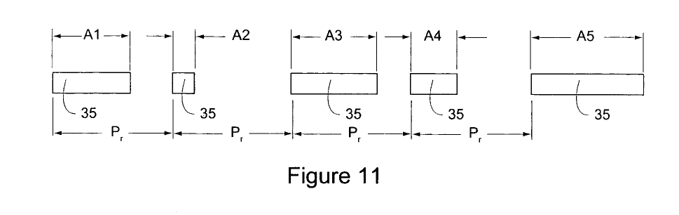

Various example embodiments of the invention have been described in terms of patterns in which one or more features repeat along an arrangement direction of the pattern. The invention however is not limited to image patterns of repeating features and can be used to form patterns of features in which the features have different sizes or shapes, but in which all of the features are arranged with a common pitch. For example, FIG. 11 shows a pattern of features 35 that that are arranged along a first direction with a uniform pitch Pᵣ (as referenced from the leftmost edge of each feature). Each of the features 35 has a different size along the first direction (shown as sizes A1, A2, A3, A4 and A5). In this example embodiment, pitch Pᵣ is not equal to an integer multiple of at least one of sizes A1, A2, A3, A4 and A5. Each feature 35 can be formed with its desired size while positioning all of the features 35 with the desired pitch Pᵣ as per various example embodiments of the invention.

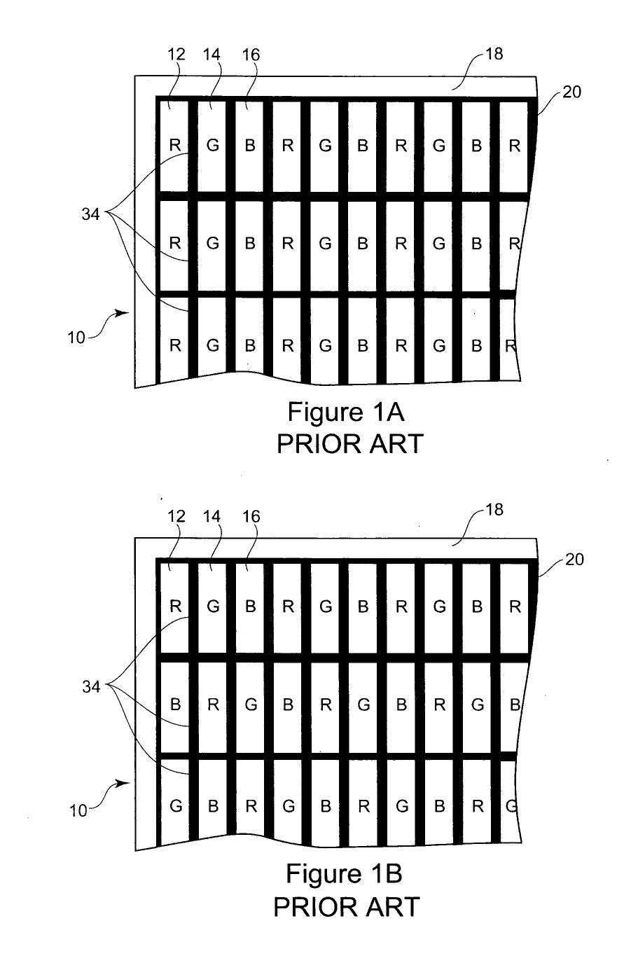

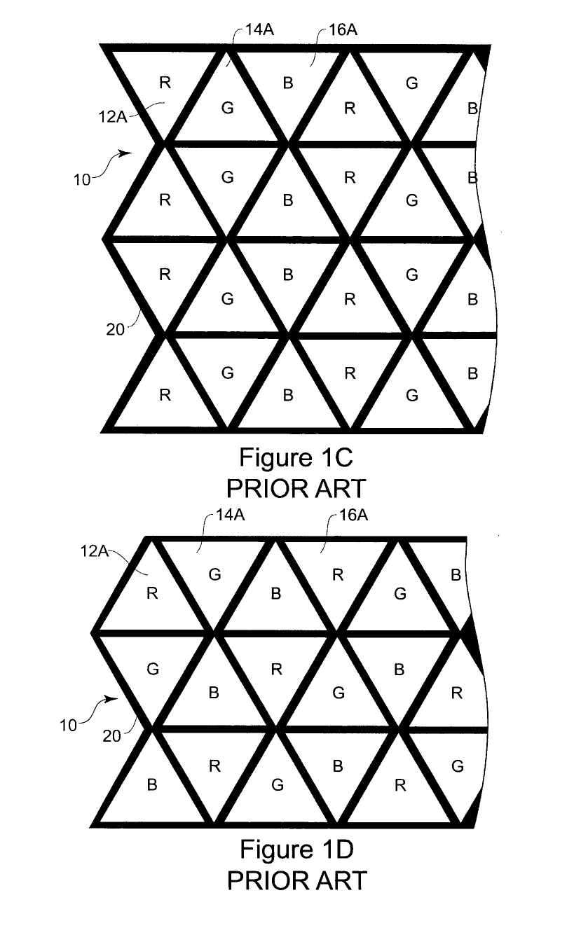

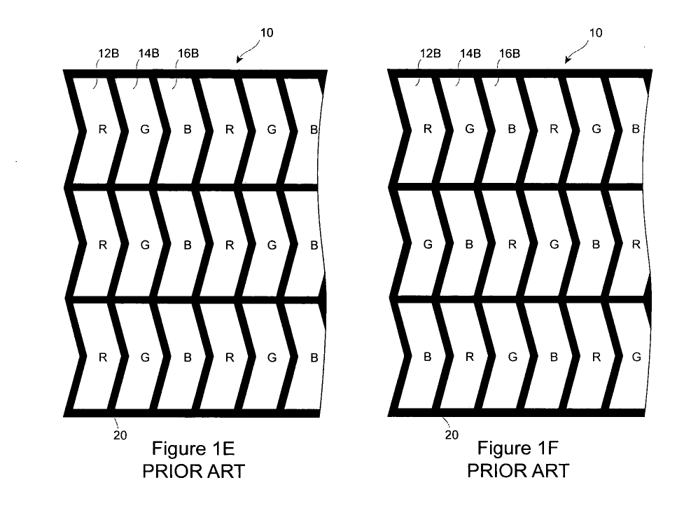

Various embodiments of the present invention have been described with reference to features that have edges that extend in directions that are substantially perpendicular to the scan direction. The present invention is not limited to these embodiments and can be used to form patterns of features that include features that have one or more edges that extend along directions that are skewed with respect to the scan direction. FIGS. 1C, 1D, 1E and 1F show example patterns of features with “skewed” edges. Skewed edges can cause the size along the scan direction of various portions of the features to vary among the various scan-lines of pixels used to form the features. In some example embodiments of the invention, pixels formed along a scan-line are sized along the scan direction based at least on the size of a feature portion along that scan-line. In some example embodiments of the invention, features that are regularly arranged in a pattern are imaged with first scan-line of pixels that includes a first pixel having a first size along the scan direction and a second pixel having a second size along the scan direction that is determined based at least on the first size and the pitch of the feature portions along the first scan-line. The features can also be imaged with a second scan-line of pixels that have at least one pixel having a size along the scan direction that is different than the first size and the second size. The second scan-line can include at least one pixel that has a size along the scan direction that is determined based on the size of another pixel in the second scan-line and the pitch of the features portions along the second scan-line.

A program product 97 can be used by controller 60 to perform various methods described herein. Program product 97 can be used by controller 60 to perform various functions required by apparatus 90. One such function can include determining a plurality of different resolutions and controlling an imaging head based on these resolutions to emit radiation beams to form pixels with varying sizes along a scan direction. These varying resolutions are determined to form a pattern of features on a media such that the features are regularly arranged along a first direction with the desired pitch and each feature, feature portion or spacing between neighboring features is formed with their desired size along the first direction. Without limitation, program product 97 may comprise any medium which carries a set of computer-readable signals comprising instructions which, when executed by a computer processor, cause the computer processor to execute a method as described herein. The program product 97 may be in any of a wide variety of forms. Program product 97 can comprise, for example, physical media such as magnetic storage media including, floppy diskettes, hard disk drives, optical data storage media including CD ROMs, DVDs, electronic data storage media including ROMs, flash RAM, or the like. The instructions can optionally be compressed and/or encrypted on the medium.

In one example embodiment of the invention, program product 97 can be used to configure controller 60 to control an imaging head to selectively emit radiation beams to form a pattern of features that are regularly arranged along a first direction on media while scanning over the media along a scan direction. The imaging head is controlled to form a plurality of pixels that can include imaged pixels and non-imaged pixels. The plurality of pixels includes a first pixel having a first size along the scan direction and a second pixel having a second different size along the scan direction. Program product 97 determines or causes controller 60 to determine a pitch of the features along the first direction, and to determine the second size of the second pixel based at least on the pitch of the features along the first direction and the first size of the first pixel. Additionally, program product 97 can determine or cause controller 60 to determine the second size of the second pixel based at least on the size along the scan direction of at least one additional pixel. Each of the at least one additional pixels can have a size along the scan direction that is different than the first size and the second size.

In the alternative, or additionally, controller 60 may permit manual adjustment of the pixel sizes under the guidance of an operator communicating with controller 60 through an appropriate user interface. Determination of the various pixel sizes can be made on the basis of suitable algorithms and/or data inputted to controller 60, or programmed within program product 97. The control parameters can be determined in advance of imaging or may be determined “on the fly” as imaging progresses.

Imaging head 26 can comprise a multi-channel imaging head having individually-addressable imaging channels, each channel capable of producing a radiation beam operable form forming an image pixel. Imaging head 26 can include various arrangements of imaging channels 40 including one-dimensional or two-dimensional arrays of imaging channels 40. Any suitable mechanism may be used to generate radiation beams. The radiation beams may be arranged in any suitable way.

Some embodiments of the invention employ infrared lasers. Infrared diode laser arrays employing 150 μm emitters with total power output of around 50W at a wavelength of 830 nm have been used by the present inventors in laser induced thermal transfer processes. Alternative lasers including visible light lasers may also be used in practicing the invention. The choice of laser source employed may be motivated by the properties of the media to be imaged.

Various example embodiments of the invention have been described in terms of a laser induced thermal transfer processes in which an image forming material is transferred to a receiver element. Other example embodiments of the invention can be employed with other imaging methods and media. Images can be formed on media by different methods without departing from the scope of the present invention. For example, media can include an image modifiable surface, wherein a property or characteristic of the modifiable surface is changed when irradiated by a radiation beam to form an image. A radiation beam can be used to ablate a surface of media to form an image. Those skilled in the art will realize that different imaging methods can be readily employed.

Patterns of features have been described in terms of patterns of color features in a display. In some example embodiments of the invention, the features can be part of an LCD display. In other example embodiments of the inventions, the features can be part of an organic light-emitting diode (OLED) display. OLED displays can include different configurations. For example, in a fashion similar to LCD display, different color features can be formed into a color filter used in conjunction with a white OLED source. Alternatively, different color illumination sources in the display can be formed with different OLED materials with various embodiments of the invention. In these embodiments, the OLED based illumination sources themselves control the emission of colored light without necessarily requiring a passive color filter. OLED materials can be transferred to suitable media. OLED materials can be transferred to a receiver element with laser-induced thermal transfer techniques.

While the invention has been described using as examples applications in display and electronic device fabrication, the methods described herein are directly applicable to other applications including those used in biomedical imaging for lab-on-a-chip (LOC) fabrication. LOC devices may include various patterns of features. The invention can have application to other technologies, such as medical, printing and electronic fabrication technologies.

It is to be understood that the exemplary embodiments are merely illustrative of the present invention and that many variations of the above-described embodiments can be devised by one skilled in the art without departing from the scope of the invention.

What is claimed is:

1. A method for forming an image of a pattern of features on media with radiation beams emitted by an imaging head while scanning over the media along a scan direction, wherein the features in the pattern are regularly arranged along a first direction; the method comprising:
determining a pitch of the features along the first direction; and
controlling the imaging head to selectively emit the radiation beams to form the image on the media with a plurality of pixels, the plurality of pixels including a first pixel having a first size along the scan direction and a second pixel having a second size along the scan direction, wherein the second size is different from the first size and is determined based at least on the pitch of the features along the first direction and the first size.

2. A method according to claim 1, wherein the pitch of the features along the first direction is not equal to an integer multiple of either the first size or the second size.

3. A method according to claim 1, wherein the pattern of features includes a feature that repeats along the first direction.

4. A method according to claim 1, wherein the first size is determined based at least on a size along the first direction of a feature of the pattern of features.

5. A method according to claim 1, wherein the second size is determined based at least on a size along the first direction of a feature of the pattern of features.

6. A method according to claim 1, wherein the first size is determined based at least on a size along the first direction of a first portion of a feature of the pattern of features, wherein the first portion of the feature is less than the entirety of the feature.

7. A method according to claim 1, wherein the first size is determined based at least on spacing along the first direction between two adjacent features of the pattern of features.

8. A method according to claim 1, wherein each of the first pixel and the second pixel are imaged pixels, the method comprising forming at least part of a feature of the pattern of features with each of the first pixel and the second pixel.

9. A method according to claim 1, wherein the plurality of pixels include imaged pixels and non-imaged pixels, the method comprising forming a feature of the pattern of features with at least one of the imaged pixels and forming a spacing between the feature and an adjacent feature of the pattern of features with at least one of the non-imaged pixels, wherein each of the at least one of the imaged pixels has a size along the scan direction that is equal to one of the first size and the second size, and each of the at least one or more of the non-imaged pixels has a size along the scan direction equal to the other of the first size and the second size.

10. A method according to claim 1, comprising forming a first portion of a feature of the pattern of features with one or more pixels that each have a size along the scan direction equal to the first size, and forming a second portion of the feature with one or more pixels having a size along the scan direction equal to the second size, wherein the first portion of the feature is different in size from the second portion of the feature at least in the first direction.

11. A method according to claim 10, wherein the first portion of the feature is different in size from the second portion of the feature in a second direction that intersects the first direction.

12. A method according to claim 10, wherein the pitch of the features along the first direction is not equal to an integer multiple of either the size along the first direction of the first portion of the feature or the size along the first direction of the second portion of the feature.

13. A method according to claim 10, wherein one of the first portion of the feature and the second portion of the feature is part of a notch in an edge of the feature.

14. A method according to claim 1, wherein the features in the pattern of features are regularly arranged along a second direction that intersects the first direction, the method comprising:
determining a pitch of the features along the second direction; and
controlling the imaging head to form each of the first pixel and the second pixel with a third size along a direction that intersects the scan direction, wherein the third size is determined based at least on the pitch of the features along the second direction.

15. A method according to claim 14, wherein the pattern of features includes a feature that repeats along the second direction.

16. A method according to claim 14, wherein the third size is determined such that the pitch of the features along the second direction is equal to an integer multiple of the third size.

17. A method according to claim 14, wherein controlling the imaging head to form each of the first pixel and the second pixel with the third size comprises rotating the imaging head to change a resolution of the imaging head.

18. A method according to claim 1, wherein the imaging head comprises a light valve, the method comprising making the second size different from the first size by varying the length of time during which one or more channels of the light valve are turned on and off.

19. A method according to claim 1, wherein the first direction is parallel to the scan direction.

20. A method according to claim 1, comprising forming the image on the media with a thermal transfer process.

21. A method according to claim 1, wherein the pattern of features comprises a plurality of different colored features and the features for each color are imaged separately.

22. A method according to claim 1, wherein the pattern of features comprises a pattern of color filter features.

23. A method according to claim 1, wherein the pattern of features is pattern of identical features.

24. A method for forming an image of a pattern of features on media with radiation beams emitted by an imaging head while scanning over the media along scan lines extending in a scan direction, wherein the features of the pattern are regularly arranged along a first direction; the method comprising:
determining a pitch of the features along the first direction;
controlling the imaging head to selectively emit the radiation beams to form the image on the media with pixels; and
controlling the imaging head to form a scan line comprising a group of the pixels, wherein the group of the pixels comprises a first pixel having a first size along the scan direction and a second pixel having a second size along the scan direction, and wherein the second size is different from the first size and the combined size along the scan direction of all the pixels in the group of pixels is equal to the determined pitch of the features along the first direction.

25. A method according to claim 24, wherein the pitch of the features along the first direction is not equal to an integer multiple of either the first size or the second size.

26. A method according to claim 24, wherein the pattern of features includes a feature that repeats along the first direction.

27. A method according to claim 24, wherein the group of the pixels comprises imaged pixels and non-imaged pixels.

28. A method according to claim 24, comprising forming a portion of a feature of the pattern of features with at least one of the first pixel and the second pixel.

29. A method according to claim 24, comprising forming a portion of a spacing between two adjacent features in the pattern of features with at least one of the first pixel and the second pixel.

30. A method according to claim 24, comprising forming a portion of a feature of the pattern of features with one or more pixels that include one of the first pixel and the second pixel, wherein the pitch of the features along the first direction is not equal to an integer multiple of a size of the portion of the feature along the first direction.

31. A method according to claim 24, comprising forming a portion of a spacing between two adjacent features in the pattern of features with one or more pixels that include one of the first pixel and the second pixel, wherein the pitch of the features along the first direction is not equal to an integer multiple of a size of the portion of the spacing along the first direction.

32. A method according to claim 24, comprising forming a portion of a notch in an edge of a feature of the pattern of features with one of the first pixel and the second pixel.

33. A method according to claim 32, wherein the notch repeats along the first direction.

34. A method according to claim 24, wherein the features in the pattern of features are regularly arranged along a second direction that intersects the first direction, the method comprising:
determining a pitch of the features along the second direction; and
forming at least one of the first pixel and the second pixel with a third size along a direction that intersects the scan direction, wherein the pitch of the features along the second direction is an integer multiple of the third size.

35. A method according to claim 34, wherein the pattern of features includes a feature that repeats along the second direction.

36. A method according to claim 24, wherein the first direction is parallel to the scan direction.

37. A method for forming an image of a pattern of features on media with radiation beams emitted by an imaging head while scanning over the media along a scan direction, wherein the features of the pattern are regularly arranged along a first direction; the method comprising:
determining a pitch of the features along the first direction;
determining a first size along the first direction of a portion of a feature of the pattern of features, wherein the pitch of the features along the first direction is not equal to an integer multiple of the first size;
controlling the imaging head to selectively emit the radiation beams to form the image on the media with a plurality of varying sized pixels;
controlling the imaging head to form an arrangement of first pixels on the media, the arrangement of first pixels having a combined size along the scan direction equal to the determined first size; and
controlling the imaging head to form one or more additional pixels on the media, wherein each of the one or more additional pixels has a different size than each of the first pixels.

38. A method according to claim 37, wherein each of the one or more additional pixels has a size along the scan direction that is different than a size of each of the first pixels along the scan direction.

39. A method according to claim 37, wherein the pitch of the features along the scan direction is not equal to an integer multiple of a size along the scan direction of each of the one or more additional pixels.

40. A method according to claim 37, wherein the first direction is parallel to the scan direction.

41. A method for forming an image of a pattern of features on media with radiation beams emitted by an imaging head while scanning over the media along a scan direction, wherein the features of the pattern are regularly arranged along a first direction; the method comprising:
determining a pitch of the features along the first direction;
determining a size along the first direction of a portion of a feature of the pattern of features, wherein the pitch of the features along the first direction is not equal to an integer multiple of the size;
controlling the imaging head to selectively emit the radiation beams to form the image on the media with a plurality of pixels of different sizes, wherein the plurality of pixels includes a first pixel having a first size along the scan direction that is determined based at least on the pitch of the features along the first direction and the determined size along the first direction of the portion of the feature.

42. A method according to claim 41, wherein the plurality of pixels includes a second pixel, the second pixel having a size along the scan direction that is different than the first size.

43. A method according to claim 41, wherein the plurality of pixels includes a second pixel, and wherein the determined size along the first direction of the portion of the feature is an integer multiple of a size along the scan direction of the second pixel.

44. A method according to claim 41, wherein the plurality of pixels includes a second pixel, and wherein the pitch of the features along the scan direction is not an integer multiple of a size along the scan direction of the second pixel.

45. A method according to claim 41, wherein the first direction is parallel to the scan direction.

46. A program product carrying a set of computer-readable signals comprising instructions which, when executed by a controller, cause the controller to:
control an imaging head to selectively emit radiation beams to form an image of a pattern of features with a plurality of pixels while scanning over media along a scan direction, wherein the features of the pattern are regularly arranged along a first direction, and the plurality of pixels includes a first pixel having a first size along the scan direction and a second pixel having a second size along the scan direction, wherein the second size is different from the first size;
determine a pitch of the features along the first direction; and
determine the second size based at least on the pitch of the features along the first direction and the first size.

47. A program product carrying a set of computer-readable signals comprising instructions which, when executed by a controller, cause the controller to:
control an imaging head to emit radiation beams to form an image of a pattern of features on media with pixels while scanning over the media along scan lines extending along a scan direction, wherein the features of the pattern are regularly arranged along a first direction;
determine a pitch of the features along the first direction; and
control the imaging head to form a scan line comprising a group of the pixels, wherein the group of the pixels comprises a first pixel having a first size along the scan direction and a second pixel having a second size along the scan direction, and wherein the second size is different from the first size and the combined size along the scan direction of all the pixels in the group of pixels is equal to the determined pitch of the features along the first direction.

48. A method according to claim 24, wherein the pitch of the features along the first direction is not equal to an integer multiple of a size along the scan direction of at least one pixel of the group of pixels.

49. A method according to claim 1, wherein the pattern of features includes a feature comprising one or more edges that extend along a direction that is skewed with respect to the scan direction.

50. A method according to claim 24, comprising controlling the imaging head to form a second scan line, the second scan line comprising at least one pixel having a size along the scan direction that is different than each of the first size and the second size.

51. A method according to claim 14, wherein the second direction is substantially perpendicular to the first direction.

52. A method according to claim 14, wherein the direction that intersects the scan direction is substantially perpendicular to the scan direction.
